(19) United States
(12) Patent Application Publication
(10) Pub. No.: US 2015/0001343 A1
(43) Pub. Date: Jan. 1, 2015

(54) LINKING AN AIRCRAFT FUSELAGE MEMBER AND A FRAME BY A CLIP AND A SPACER

(71) Applicant: AIRBUS OPERATIONS (SAS), Toulouse (FR)

(72) Inventors: Philippe BERNADET, Colomiers (FR); Yannick MARIN, L'lsle Jourdain (FR)

(21) Appl. No.: 14/313,593

(22) Filed: Jun. 24, 2014

(30) Foreign Application Priority Data
Jun. 28, 2013 (FR) 1356321

(51) Int. Cl. B64C 1/06

(52) U.S. Cl. CPC B64C 1/069; B64C 1/064
USPC 244/119; 244/131

(57) ABSTRACT

An aircraft fuselage member and a frame are linked by a clip and a spacer. An assembly includes an aircraft fuselage member, having a skin and stringers linked to the skin, a reinforcing frame, and a clip rigidly linking the fuselage member and the frame. The clip is rigidly linked to the skin via a spacer, independent from the stringers, interposed between the fuselage member and the clip. An aircraft fuselage part includes several assemblies so defined. The cost of a fuselage is thereby reduced by standardization of the clips and/or reduction of the maximum width of the stringers.

### CROSS REFERENCE TO RELATED APPLICATION

This application is entitled to and claims the benefit of French Application No. 1356321 filed Jun. 28, 2013, the disclosure of which, including the specification, claims, drawings and abstract, are incorporated herein by reference in their entirety.

### FIELD

The present invention relates to the mechanical link between an aircraft fuselage member and a reinforcing frame by means of a clip.

It relates to the general field of the construction of aeronautical structures.

### BACKGROUND

Aircraft fuselages, in particular aeroplane fuselages, are commonly constituted by fuselage members comprising a skin made from metal or a composite material. The skin corresponds to the outer shell of the fuselage. Said skin is rigidly linked to stringers, which are longitudinal structural members, i.e. positioned substantially parallel to the main axis of the fuselage once the latter has been constituted. The stringers reinforce and stiffen the skin in the longitudinal direction. The transverse rigidity, as well as the positioning of the fuselage member, are obtained by linking the fuselage member to a frame. The frame can typically be substantially circular in shape.

The mechanical link between a fuselage member and its frame is carried out, in a known manner, by means of a clip, also known as connector or fastener, generally in form of an angle bracket. The clip is rigidly linked on the one hand to the frame, and on the other hand to the fuselage member. The clip is intended to create a rigid link between the skin and the frame. However, in order to ensure a good contact surface at the link between the clip and the fuselage member, it is known to use stringers having a locally widened flange, to which the clip is linked.

This solution is however costly to implement. Firstly, the manufacturing cost of a stringer is directly associated with its maximum width. Said maximum width generally corresponds to the width of the stringer flanges where they are locally widened for the purpose of receiving the clip. Moreover, an aeroplane fuselage often has a cross-section and/or geometry that vary significantly longitudinally, so that clips of several dimensions and/or shapes are required in order to constitute a single fuselage. Said diversity results in significant costs in the manufacture of the clips, which are generally moulded parts made from composite material. Several moulds are required, and in practical terms, the clips must be redesigned for each new fuselage.

The invention therefore aims to reduce the cost of the link between a fuselage member and a structural frame, by reducing the diversity of the clips used.

### SUMMARY

To this end, the invention relates to an assembly comprising:
an aircraft fuselage member, comprising a skin and stringers linked to said skin;
a reinforcing frame;
a clip rigidly linking the fuselage member and the frame;
in which the clip is rigidly linked to the skin via a spacer, independent from the stringers, interposed between said fuselage member and the clip.

The use of a spacer in the rigid link between the clip and the skin allows the use of a standardized clip for a large number of links, by a simple adaptation of the spacer. This allows a reduction in the manufacturing costs of a fuselage. Adapting a spacer, which is a member that is simple to manufacture or form, is less costly than adapting a clip, which is a more complex part. Moreover, the fact that the spacer is independent from the stringers, i.e. not constituted thereby, makes it possible to reduce the maximum width of the stringers and therefore their manufacturing cost.

According to a first embodiment of the invention, the spacer is an additional part.

The spacer can be made from composite material, preferentially of the short-fibre type or of the long-discontinuous-fibre type.

The fuselage member can be linked to the clip by fixing means passing through the spacer.

In a variant of the invention in which the skin is made from composite material and the spacer is made from composite material, the skin and the spacer can be linked by welding. The resins used in the materials constituting the skin and the spacer must be identical or at least compatible for such welding. The methods of implementation of the composite materials must be equivalent.

Typically, the welding can be carried out by co-consolidation.

Preferably, the spacer comprises a face known as the lower face in contact with the skin, the lower face being shaped so as to follow the local shape of the skin in the contact area.

According to a second embodiment of the invention, as the skin is made from composite material, the spacer is an extra thickness of the skin obtained from moulding. Preferably, the spacer is then made from short-fibre filled resin, introduced locally during moulding according to a moulding process known as “in-mould finishing”.

According to two variants of the invention, the spacer has no direct contact with the stringers, or the spacer covers a flange of the stringers at least partially.

Preferably, the spacer comprises a face known as the upper face having a concave shape, said clip having a corresponding convex surface in contact with the concave face of the spacer, so as to form a swivel connection between the clip and the spacer before fixing.

The invention also relates to a fuselage section of an aircraft comprising several assemblies such as those previously described, in which the clips are identical while the spacers associated with said clips have different geometries.

In such a fuselage section, the thickness of the spacers can be adapted, for each link between a clip and the skin, depending on the distance between one end of the clip and the skin. If the spacers are additional parts, they can be adapted according to the local curvature of the fuselage member.

### BRIEF DESCRIPTION OF DRAWINGS

Further features and advantages of the invention will become apparent from the following description.

In the attached drawings, given as non-limitative examples:

FIG. 1a shows a three-dimensional view of an assembly comprising a fuselage member, a frame, and their linking clip, according to the prior art;

FIG. 1b shows a detail view of the link between a frame and a fuselage member, according to the prior art;

FIG. 2 shows a diagrammatic three-dimensional view of an assembly according to an embodiment of the invention;

FIG. 3 shows a spacer and a clip as implemented in a first embodiment of the invention;

FIG. 4 shows a detail view of a fuselage skin made from composite material incorporating a spacer, as implemented in a second embodiment of the invention;

FIG. 5 shows a detail view of a first variant of the invention; and

FIG. 6 shows a detail view of a second variant of the invention.

### DETAILED DESCRIPTION OF EMBODIMENTS

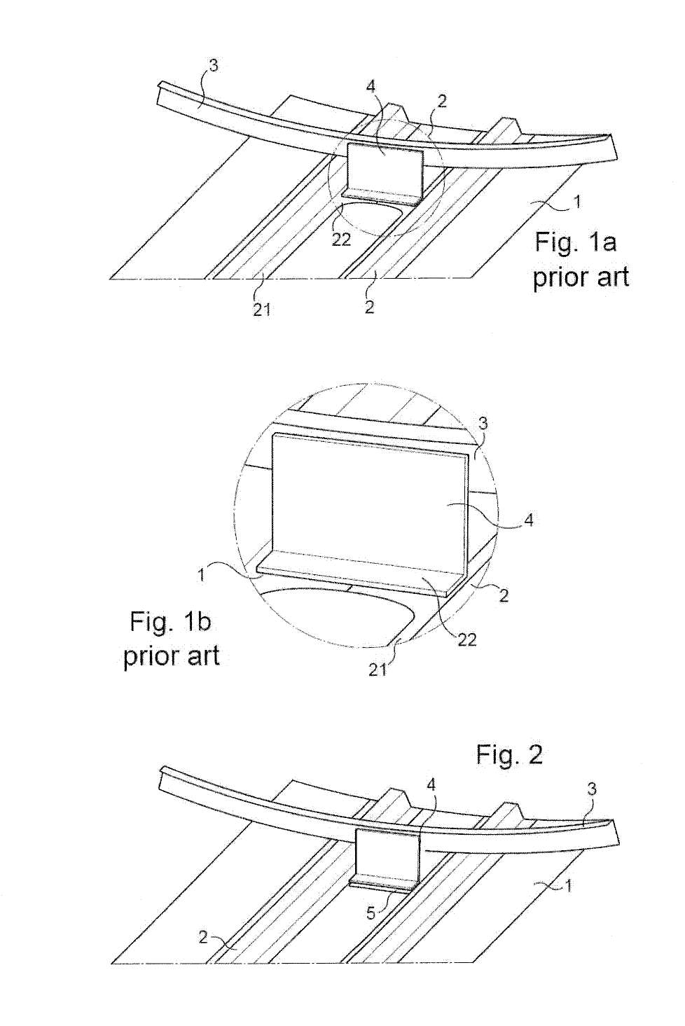

In the state of the art, an aeroplane fuselage can be constituted by assembling fuselage members. A method of assembly known in the state of the art is shown in FIGS. 1a and 1b. The fuselage members comprise a skin 1, and stringers 2. The stringers 2 are fixed to the skin 1, and extend longitudinally, i.e. substantially in the direction of the main axis of the fuselage, once the latter is constituted.

The skin 1 is a sheet made from metal or composite material, which constitutes the outer shell of a fuselage.

The stringers 2 are linked to the inner face of the skin 1, i.e. the face intended to be towards the inside of the fuselage, and have a cross-section extending towards the inside of the fuselage. The cross-section of the stringers 2 can typically be in the shape of a “T”, “J”, or omega. Other cross-sections can be envisaged for example, non-limitatively, “S”, or “I”. The stringers have significant flexural strength. They generally have a flange 21, i.e. a shoulder increasing the contact surface area with the skin 1. Rigidly linked to the skin 1, the stringers 2 reinforce it and stiffen it in the longitudinal direction.

When the skin 1 is made from metal or composite material, the stringers 2 and the skin 1 can be assembled using fixing means passing through the stringers 2 and the skin 1. The fixing means can be rivets.

When the skin is made from composite material, the stringers 2, also made from composite material, can be linked to the skin 1 during the moulding thereof.

In order to constitute a fuselage, the fuselage members comprising the skin 1 and the stringers 2 are assembled in a known manner on frames 3. The link between a frame 3 and a fuselage member uses a clip 4. The frame reinforces the fuselage member transversally, and ensures the accurate positioning thereof.

The clip 4 is rigidly linked, on the one hand to the frame 3, and on the other hand to the fuselage member. More specifically, the function of the clip 4 is to provide a rigid link between the skin 1 and the frame 3. However, in order to ensure a good contact surface at the link between the clip 4 and the fuselage member, it is known to use stringers 2 comprising a local widening 22 of the flange 21. The clip is then linked to the fuselage member at the widening 22.

However, this solution is costly because the manufacturing cost of a stringer 2 is directly linked to its width, governed by the widening 22 of the flange 21. Moreover, the clip 4 must be adapted to each of the links, as the distance between the skin 1 and the frame 3, as well as the geometry of the skin, in particular its curvature, can vary from one link to another in a single fuselage. This leads to the use of numerous different clip part numbers.

In the invention, an embodiment of which is shown diagrammatically in FIG. 2, the clip 4 is rigidly linked to the skin 1 of the fuselage member via a spacer 5, independent from the stringers 2, i.e. not constituted by the stringers 2, interposed between said fuselage member and the clip 4.

The thickness of each spacer 5 and/or its geometry are adapted to the link in question between the frame 3 and the skin 1. It is thus possible to use a single part number or a small number of part numbers for the clips 4 in order to constitute an entire fuselage.

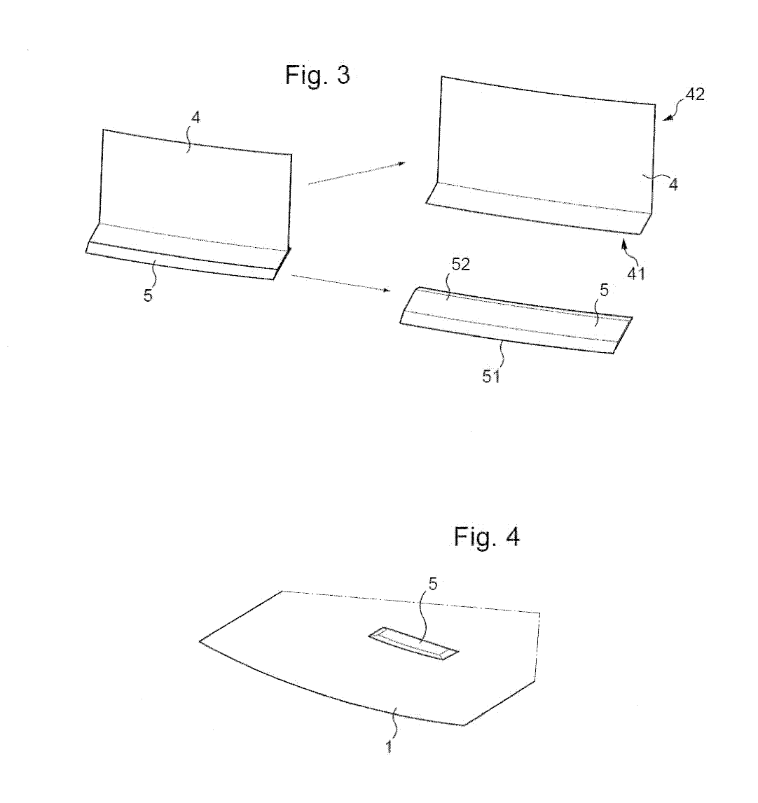

According to a first embodiment of the invention, the spacer 5 is an additional part. FIG. 3 shows an example of a spacer and a clip, as implemented in said first embodiment. On the left of the figure a spacer 5 and a clip 4 are shown as they are positioned with respect to each other after assembly of a fuselage member on a frame. On the right the spacer 5 and the clip 4 are shown separated from each other.

The clip 4 has two perpendicular faces, allowing surface contact substantially in a longitudinal plane of the fuselage member between a first face 41 of the clip and the spacer 5, and surface contact in a transverse plane substantially perpendicular to the longitudinal plane, between a second face 42 of the clip and the frame 3. By way of example, a clip 4 having a substantially “L”-shaped cross-section makes this possible.

The spacer 5 is geometrically adapted to the link between clip 4 and skin 1 in which it is implemented. The spacer 5 is interposed between the clip 4 and the skin 1. The skin 1, spacer 5, and clip 4 can in particular be fixed together by fixing means passing through the spacer 5. Typically the fixing means can be rivets. Each link between skin 1, spacer 5 and clip 4 comprises preferably at least three rivets, typically four rivets. The fixing means allow the spacer 5 to be held between the clip 4 and the skin 1.

The spacer 5 is preferentially produced by moulding a composite material. Among the composite materials, a composite of the type known as short-fibre is preferred. A composite of the type known as short-fibre is a material constituted by a matrix filled with fibres 0.1 mm to 1 mm in length.

The use in the invention of a short-fibre composite material for constituting the spacer 5 is compatible with the low loads to which the spacer 5 is subjected. Said material can be manufactured easily and in a controlled manner, with low geometric tolerances, making it possible to shape the spacer accurately to the required geometry.

When the spacer 5 is made from composite material, and the skin 1 is also made from composite material, it is possible to link the spacer and the skin by co-consolidation, subject to the composite materials being compatible. This is typically the case if they comprise the same matrix resin. This is also the case for the spacer 5 and the clip 4, which can if necessary be linked by co-consolidation.

Co-consolidation is often known by the term “co-curing”.

In the embodiment shown here, the spacer 5 has a face known as the lower face 51. The lower face is intended to be in contact with the skin 1 of the fuselage. The lower face 51 is shaped so as to follow the local shape of the skin 1 in the contact area for which it is intended. Thus, the lower face 51 has a slightly domed shape, in one or two directions, in order to fit the curvature (or curvatures) of the skin in the contact area.

The spacer 5 shown here also comprises a face known as the upper face 52.

The upper face 52 of the spacer advantageously has the same geometry as the lower face of the clip. Said corresponding shape allows good contact between the spacer and the clip. The dimensions of the upper face 52 are typically identical to, or smaller than, those of the lower face of the clip, thus allowing the take-up of some play in the relative positioning of the clip with respect to the spacer.

The upper face 52 is preferentially concave in shape, for example a portion of a sphere. The slight concavity of the upper face 52, associated with a corresponding convexity of the first face 41 of the clip, provides up to three degrees of freedom and can form a swivel connection locally. The degrees of freedom thus provided before fixing the assembly allow easier positioning of the clip. Some geometrical variations can also be taken up in this way.

According to a second embodiment of the invention, the spacer 5 and the skin 1 are made from a single piece. According to said second embodiment, the skin is made from composite material. A detail view of a fuselage skin made from composite material incorporating a spacer is shown in FIG. 4. The spacer 5 is then an extra thickness of the skin 1, obtained by moulding. The moulding process used can advantageously be a process known as “in-mould finishing” or “semi-finishing” often referred to as “net-shape” or “near net-shape” forming. In such methods, the part removed from the mould has geometrical and surface characteristics such that machining before use is not required (or not essential).

According to said methods, the spacer 5 can be formed by the injection of resin, typically short-fibre filled, at the end of moulding of the skin 1, or the fuselage member.

The spacer 5 can also comprise, instead of the short fibres, long discontinuous fibres generally known as “chopped fibres”. The composite material obtained is known as “forged carbon”. The long fibres used have a length of the order of one centimetre or a few centimetres.

This embodiment of the invention is particularly advantageous, in that it allows the direct production of the spacer adapted to the link in question. With respect to thickness, the chain of dimensions and tolerances of the assembly is simplified, because there is a single interface between the skin 1, incorporating the spacer 5, and the clip 4.

In this embodiment, the clip 4 can be linked to the spacer 5 by co-consolidation, subject to compatibility between the composite materials constituting these parts.

According to said second embodiment, the spacer can have an upper face 52 that has a concave shape, the clip 4 having a correspondingly convex first face 41. The advantages in terms of freedom of positioning and take-up of tolerances are identical to those previously described for the first embodiment.

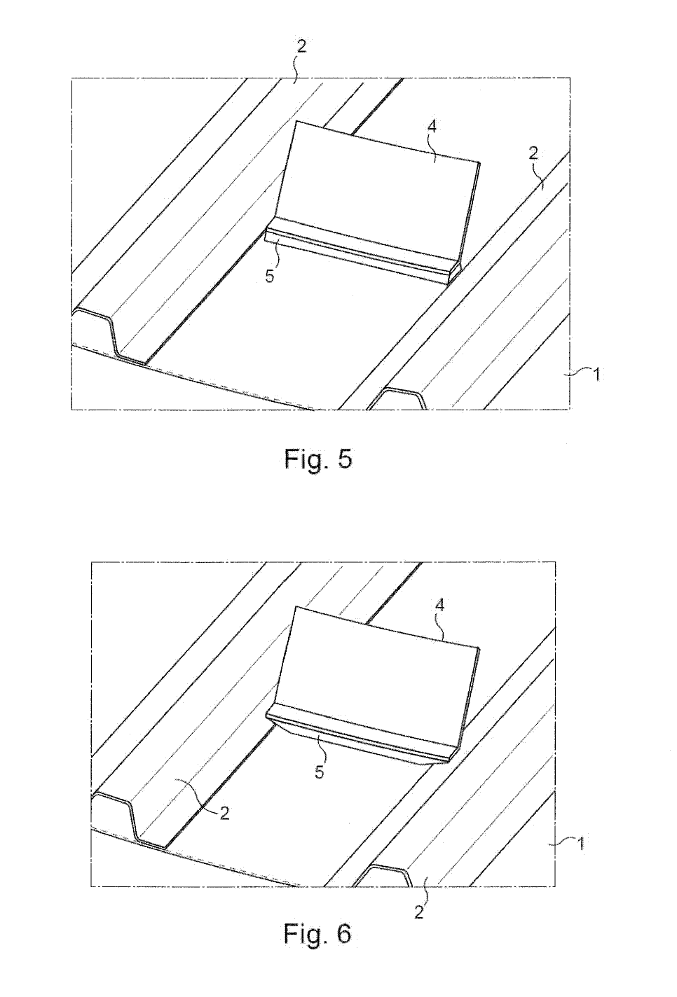

Regardless of the embodiment of the invention, two variants, shown respectively in FIGS. 5 and 6, can be envisaged in the implementation of the invention. The implementation of one or other of these variants depends essentially on the geometrical characteristics of the fuselage member, and in particular on the distance separating two stringers 2.

According to a first variant, shown in FIG. 5, the spacer 5 has no direct contact with the stringer 2. The spacer is thus linked to the fuselage member only at the level of the skin 1. This solution is suitable in particular when the stringers 2 are far enough apart to allow a satisfactory link between the spacer and the skin and the clip. If the link is made by fixing means passing through the spacer 5, typically rivets, the distance separating the stringers 2 that governs the width of the spacer 5 must be sufficient to accommodate an adequate number of linking means, for example three or four. In the frame of an airliner fuselage, the minimum distance between two stringers allowing the use of said first variant can be of the order of 200 mm. Said first variant is obviously compatible with the first and second embodiments of the invention previously disclosed.

According to a second variant of the invention, shown in FIG. 6, the spacer at least partially covers the flange 21 of the stringer. This solution is particularly suitable when the stringers 2 are not far enough apart to allow a satisfactory link between the spacer and the skin or the clip. This can typically be the case for an airliner fuselage when the distance between two stringers is less than 200 mm. It should be noted that said variant is also compatible with the two embodiments previously disclosed. In the second embodiment of the invention, the fuselage member comprising a skin 1 incorporating the spacer 5 and stringers 2 can be produced in a single moulding process in which these members are co-moulded and/or bonded together.

The invention thus described finds its industrial application in the aeronautical field, allowing the use of a limited number of different clips for assembling a fuselage. It also allows the manufacturing costs of the fuselage stringers to be reduced, in that it limits the maximum width thereof by dispensing with the local widening of the stringer flanges.

1. Assembly comprising:
an aircraft fuselage member, comprising a skin and stringers linked to said skin;
a reinforcing frame;
a clip rigidly linking the fuselage member and the frame;
characterized in that the clip is rigidly linked to the skin via a spacer, independent from the stringers, interposed between said fuselage member and the clip.

2. Assembly according to claim 1, in which the spacer is an additional part.

3. Assembly according to claim 2, in which the spacer is made from composite material, preferentially of the short-fibre type or of the long-discontinuous-fibre type.

4. Assembly according to claim 2, in which the fuselage member is linked to the clip by fixing means passing through the spacer.

5. Assembly according to claim 3, the skin being made from composite material, in which the skin and the spacer are linked by welding.

6. Assembly according to claim 2, in which the spacer comprises a face known as the lower face in contact with the skin, the lower face being shaped so as to follow the local shape of the skin in the contact area.

7. Assembly according to claim 1, in which, when the skin is made from composite material, the spacer is an extra thickness of the skin obtained by moulding.

8. Assembly according to claim 7, in which the spacer is made from short-fibre filled resin, introduced locally during moulding, according to a moulding process known as “in-mould finishing”.

9. Assembly according to claim 1, in which the spacer has no direct contact with the stringers.

10. Assembly according to claim 1, in which the spacer at least partially covers a flange of the stringers.

11. Assembly according to claim 1, in which the spacer comprises a face known as the upper face having a concave shape, said clip having a corresponding convex surface in contact with the concave face of the spacer, so as to form a swivel connection between the clip and the spacer before fixing.

12. Aircraft fuselage section comprising several assemblies according to claim 1, in which the clips are identical while the spacers associated with said clips have different geometries.

13. Fuselage section according to claim 12, in which the thickness of the spacers is adapted for each link between a clip and the skin, depending on the distance between an end of the clip and the skin.

14. Fuselage section according to claim 12, in which the spacers are additional parts, adapted according to the local curvature of the fuselage member.

15. Fuselage section according to claim 13, in which the spacers are additional parts, adapted according to the local curvature of the fuselage member.
